(19) United States
(12) Patent Application Publication
(10) Pub. No.: US 2009/0148045 A1
(43) Pub. Date: Jun. 11, 2009

(54) APPLYING IMAGE-BASED CONTEXTUAL ADVERTISEMENTS TO IMAGES

(75) Inventors: PHILIP LEE, BELLEVUE, WA (US); HENG ZHANG, BELLEVUE, WA (US); LEE-MING ZEN, SEATTLE, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, REDMOND, WA (US)

(21) Appl. No.: 11/952,290

(22) Filed: Dec. 7, 2007

(51) Int. Cl. G06K 9/46

(52) U.S. Cl. 382/190

(57) ABSTRACT

Systems, methods, computer-readable media, and graphical user interfaces for applying image-based contextual advertisements to images are provided. An image analyzing module and advertisement analyzing module analyze images and advertisements to identify image attributes and advertisement attributes. Upon identifying image attributes and advertisement attributes, advertisements deemed contextually relevant to an image are determined. In some embodiments, the contextually relevant advertisements are ranked. Thereafter, one or more contextually relevant advertisements are associated with the image. The one or more contextually relevant advertisements are presented based on preferences and/or features.

### BACKGROUND

Online advertising has become a significant source of revenue. Today, many search engines and advertisers receive revenue through advertisements presented online. For example, many search engine providers and advertisers receive payment upon a user's selection of an advertisement. Advertisements that are contextually relevant to the associated online content may be even more frequently selected. Accordingly, presenting contextually relevant advertisements further increases payment to search engine providers and advertisers.

### BRIEF SUMMARY

Embodiments of the present invention relate to systems, graphical user interfaces, and computer-readable media for applying image-based contextual advertisements to images. Images and advertisements are analyzed to identify image-associated attributes and advertisement attributes. Upon identifying image-associated attributes and advertisement attributes, advertisements deemed contextually relevant to an image are determined. The contextually relevant advertisements may be ranked. One or more advertisements that are contextually relevant to the image are associated with the image. The image and advertisement are evaluated such that the advertisement may be integrated with the image. Such an integration may be based on preferences, feature effects, or a combination thereof. The integrated advertisement and image are presented.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Embodiments are described in detail below with reference to the attached drawing figures, wherein:

FIG. 1 is a block diagram of an exemplary computing environment suitable for use in implementing embodiments of the present invention;

FIG. 2 is a block diagram of an exemplary computing system architecture suitable for use in implementing embodiments of the present invention;

FIG. 3 is a block diagram of an exemplary computer system for use in implementing an embodiment, in accordance with the present invention;

FIGS. 4A-4B illustrate an exemplary display of a transparency feature, in accordance with an embodiment of the present invention;

FIGS. 5A-5C illustrate an exemplary display of a zooming feature, in accordance with an embodiment of the present invention;

FIG. 6 is a flow diagram illustrating an exemplary method for analyzing an image, in accordance with an embodiment of the present invention;

FIG. 7 is a flow diagram illustrating an exemplary method for determining one or more image-based contextual advertisements to apply to an image, in accordance with an embodiment of the present invention; and

FIG. 8 is a flow diagram illustrating an exemplary method for applying an image-based contextual advertisement to an image, in accordance with an embodiment of the present invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide systems, methods, and computer-readable media for applying image-based contextual advertisements to images. Images and advertisements are analyzed to identify image attributes and advertisement attributes. Upon identifying image attributes and advertisement attributes, advertisements deemed contextually relevant to an image are determined. In some embodiments, the contextually relevant advertisements are ranked. Thereafter, one or more contextually relevant advertisements are associated with the image. The one or more contextually relevant advertisements are applied to the image and presented based on preferences and/or features.

Accordingly, in one aspect, the present invention provides one or more computer-readable media having computer-executable instructions embodied thereon that, when executed, perform a method for determining image-based contextual advertisements to apply to an image. The method includes referencing image-associated attributes, wherein at least one of the image-associated attributes comprises a primary image-associated attribute that relates to an first image-associated media comprising an image and at least one of the image-associated attributes comprises a secondary image-associated attribute that relates to a second image-associated media; and utilizing the image-associated attributes to determine one or more advertisements contextually relevant to the image.

In another aspect, the present invention provides a method for applying image-based contextual advertisements to images. The method includes identifying preferences for one of a contextually relevant advertisement or an image, wherein the preferences comprise a color preference, a position preference, a format preference, a content preference, or a combination thereof; determining the integration of the advertisement contextually relevant with the image based on identified preferences; and applying the contextually relevant advertisement to the image.

In a further aspect, the present invention provides a computerized system for applying image-based contextual advertisements to images. The system includes an image analyzing module configured to analyze image-associated media and identify image-associated attributes, wherein at least one image-associated attributes comprises a primary image-associated attribute and at least one more image-associated attributes comprises a secondary image-associated attribute; an advertisement analyzing module configured to analyze advertisements and identify advertisement attributes; an advertisement determining module configured to determine contextually relevant advertisements, wherein contextually relevant advertisements are determined based on primary image-associated attribute, secondary image-associated attribute, and advertisement attributes; and a contextual advertisement applying module configured to apply contextually relevant advertisements to the image based on preferences, features, or a combination thereof.

Having briefly described an overview of embodiments of the present invention, an exemplary operating environment suitable for implementing embodiments hereof is described below.

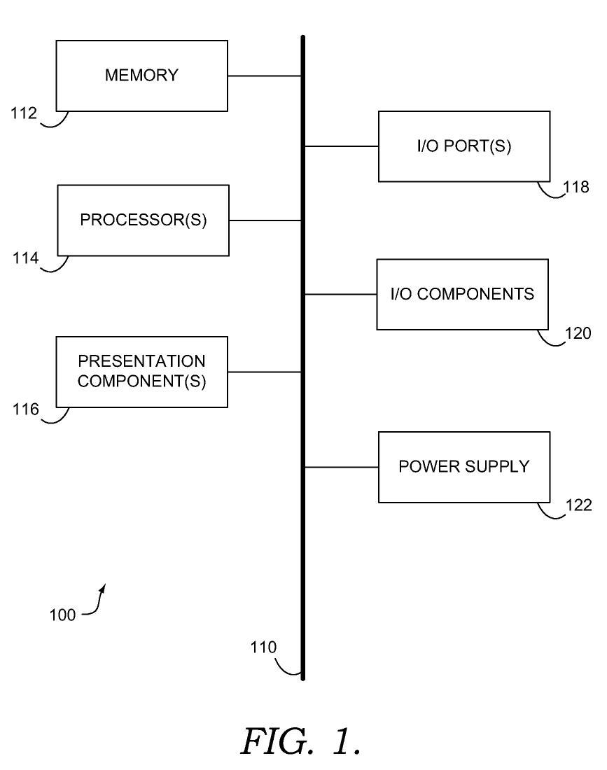

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of modules/components illustrated.

Embodiments may be described in the general context of computer code or machine-useable instructions, including computer-executable instructions such as program modules, being executed by a computer or other machine, such as a personal data assistant or other handheld device. Generally, program modules including routines, programs, objects, modules, data structures, and the like, refer to code that performs particular tasks, or implement particular abstract data types. Embodiments may be practiced in a variety of system configurations, including hand-held devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various modules is not so clear, and metaphorically, the lines would more accurately be grey and fuzzy. For example, one may consider a presentation module such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation component include a display device, speaker, printing module, vibrating module, etc. I/O ports 118 allow computing device 100 to be logically coupled to other devices including I/O modules 120, some of which may be built in. Illustrative modules include a microphone, joystick, game pad, satellite dish, scanner, printer, wireless device, etc.

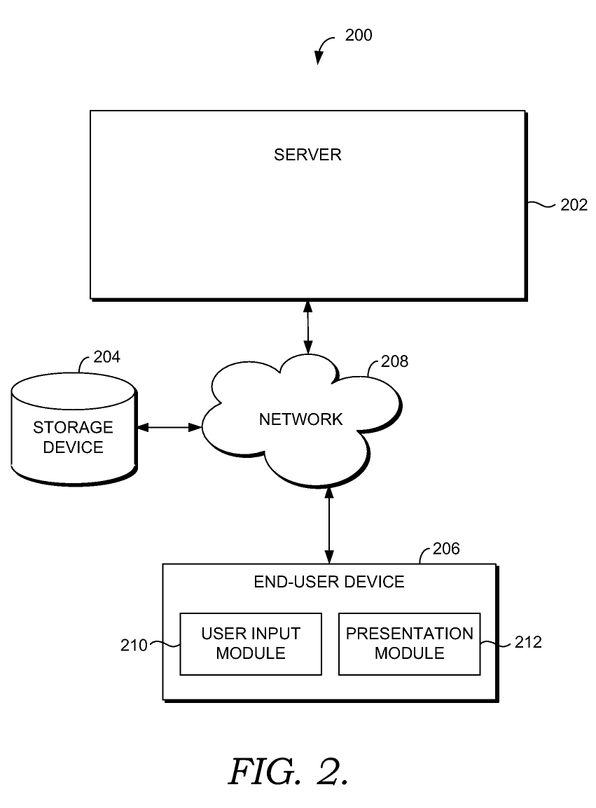

With reference to FIG. 2, a block diagram is illustrated that shows an exemplary computing system architecture 200 configured for use in implementing an embodiment of the present invention. It will be understood and appreciated by those of ordinary skill in the art that the computing system architecture 200 shown in FIG. 2 is merely an example of one suitable computing system and is not intended to suggest any limitation as to the scope of use or functionality of the present invention. Neither should the computing system architecture 200 be interpreted as having any dependency or requirement related to any single module/component or combination of modules/components illustrated therein.

Computing system architecture 200 includes a server 202, a storage device 204, an end-user device 206, all in communication with one another via a network 208. The network 208 may include, without limitation, one or more local area networks (LANs) and/or wide area networks (WANs). Such networking environments are commonplace in offices, enterprise-wide computer networks, intranets and the Internet. Accordingly, the network 208 is not further described herein.

The storage device 204 is configured to store information associated with an advertisement and/or media. In embodiments, the storage device 204 is configured to be searchable for one or more of the items stored in association therewith. It will be understood and appreciated by those of ordinary skill in the art that the information stored in the storage device 204 may be configurable and may include any information relevant to an advertisement and/or media. The content and volume of such information are not intended to limit the scope of embodiments of the present invention in any way. Further, though illustrated as a single, independent component, the storage device 204 may, in fact, be a plurality of storage devices, for instance a database cluster, portions of which may reside on the server 202, the end-user device 206, another external computing device (not shown), and/or any combination thereof.

Each of the server 202 and the end-user device 206 shown in FIG. 2 may be any type of computing device, such as, for example, computing device 100 described above with reference to FIG. 1. By way of example only and not limitation, each of the server 202 and the end-user device 206 may be a personal computer, desktop computer, laptop computer, handheld device, mobile handset, consumer electronic device, or the like. It should be noted, however, that embodiments are not limited to implementation on such computing devices, but may be implemented on any of a variety of different types of computing devices within the scope of embodiments hereof.

The server 202 may include any type of application server, database server, or file server configurable to perform the methods described herein. In addition, the server 202 may be a dedicated or shared server. One example, without limitation, of a server that is configurable to operate as the server 202 is a structured query language (“SQL”) server executing server software such as SQL Server 2005, which was developed by the Microsoft® Corporation headquartered in Redmond, Wash.

Components of server 202 (not shown for clarity) may include, without limitation, a processing unit, internal system memory, and a suitable system bus for coupling various system components, including one or more databases for storing information (e.g., files and metadata associated therewith). Each server typically includes, or has access to, a variety of computer-readable media. By way of example, and not limitation, computer-readable media may include computer-storage media and communication media. In general, communication media enables each server to exchange data via network 208. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or ore of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that computing system architecture 200 is merely exemplary. While the server 202 is illustrated as a single box, one skilled in the art will appreciate that the server 202 is scalable. For example, the server 202 may in actuality include 500 servers in communication. Moreover, the storage device 204 may be included within the server 202 or end-user device 206 as a computer-storage medium. The single unit depictions are meant for clarity, not to limit the scope of embodiments in any form.

As shown in FIG. 2, the end-user device 206 includes a user input module 210 and a presentation module 212. In some embodiments, one or more of the modules 210 and 212 may be implemented as stand-alone applications. In other embodiments, one or both of the modules 210 and 212 may be integrated directly into the operating system of the end-user device 206. It will be understood by those of ordinary skill in the art that the modules 210 and 212 illustrated in FIG. 2 are exemplary in nature and in number and should not be construed as limiting. Any number of modules may be employed to achieve the desired functionality within the scope of embodiments hereof.

The user input module 210 is configured for, among other things, receiving an indication to access image-associated media, e.g., a website. Typically, such an indication is input via a user interface (not shown) associated with the end-user device 206, or the like. Upon receiving an indication to access image-associated media, the presentation module 212 of the end-user device 206 is configured for presenting an image-based contextual advertisement. In one embodiment, the presentation module 212 presents an image-based contextual advertisement utilizing a display device associated with the end-user device 206. Embodiments, however, are not intended to be limited to visual display but rather may also include audio presentation, combined audio/video presentation, and the like.

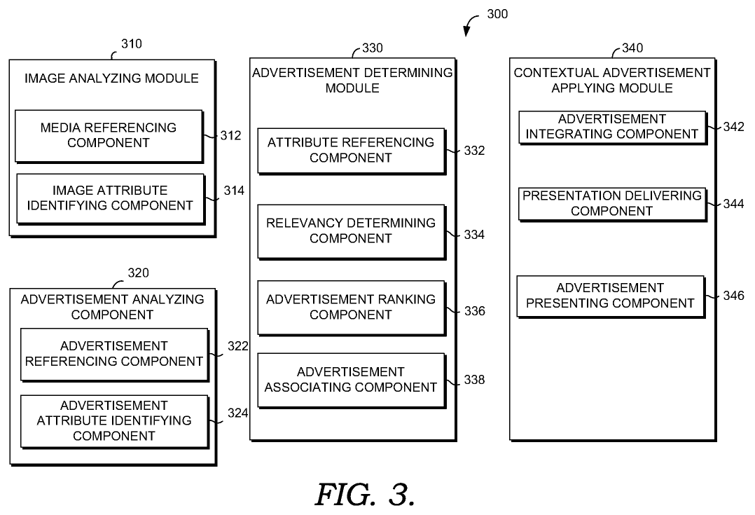

FIG. 3 illustrates an exemplary computer system 300 for applying image-based contextual advertisements to images. As used herein, the term “image-based contextual advertisement” refers to an advertisement that is contextually relevant to an image. An advertisement, as used herein, may include any advertisement including, but not limited to, a text advertisement, an image advertisement, a video advertisement, an animated advertisement, an audio advertisement, a combination thereof, or any other advertisement capable of providing a message to a user. An image refers to any graphic provided over a network, such as the internet. As such, an image may include, without limitation, photographs, drawings, line art, graphs, diagrams, typography, numbers, symbols, icons, geometric designs, maps, engineering drawings, and the like. One skilled in the art will recognize that an image may comprise any file format including, but not limited to, Joint Photographic Experts Group (JPEG), Tagged Image File Format (TIFF), Portable Network Graphics (PNG), Graphics Interchange Format (GIF), Bitmap (BMP), and the like.

As shown in FIG. 3, an exemplary computer system 300 includes an image analyzing module 310, an advertisement analyzing module 320, an advertisement determining module 330, and a contextual advertisement applying module 340. In some embodiments, one or more of the illustrated modules and/or components may be implemented as stand-alone applications. In other embodiments, one or more of the illustrated modules and/or components may be integrated directly into the operating system of the server 202, a cluster of servers (not shown) and/or the end-user device 206. It will be understood by those of ordinary skill in the art that the modules and components illustrated in FIG. 3 are exemplary in nature and in number and should not be construed as limiting. Any number of modules and/or components may be employed to achieve the desired functionality within the scope of embodiments hereof. Further, modules and components may be located on any number of servers or computers. For example, image analyzing module 310, advertisement analyzing module 320, advertisement determining module 330, and a first portion of the contextual advertisement applying module 340 may reside on distinct servers while a second portion of the contextual advertisement applying module 340 may reside on the end-user device 206.

The image analyzing module 310 is configured to analyze image-associated media. Image-associated media, as used herein, refers to any electronic media information associated with an image or prospectively associated with an image. Electronic media may comprise an analog or digital format and may include, for example, videos, audios, songs, movies, multimedia presentations, slide presentations, documents, images, games, websites, webpages, blog entries, other online content, and any portion thereof (e.g., image captions, text positioned near images, and the like). Electronic media information may include any information, such as, for example, content, data, and metadata, associated with the electronic media.

One skilled in the art will recognize that electronic media may include the image for which an image-based contextual advertisement is appropriate. By way of example only, assume an image is associated with electronic media information comprising webpage content and metadata. In such a case, image analyzing module 310 may analyze the entire webpage content and metadata, including the image for which an image-based contextual advertisement is appropriate and any other media included within the webpage, e.g., other images, videos, audios, and the like. Accordingly, image analyzing module 310 may analyze image-associated media comprising image content and metadata as well as other content and metadata associated with the image. Such a comprehensive analysis may enable the application of a more relevant image-based contextual advertisement to an image.

In one embodiment, the image analyzing module 310 may include a media referencing component 312 and an image attribute identifying component 314. The media referencing component 312 is configured to reference image-associated media such that the referenced image-associated media may be analyzed. That is, media referencing component 312 may reference any electronic media associated with an image for which an image-based contextual advertisement is appropriate.

In one embodiment, images for which image-based contextual advertisements are appropriate may be automatically designated. Such an automatic designation may occur based upon the publishing of a new or modified image. For example, upon publishing a modified image, the image may be automatically designated as an image for which an image-based contextual advertisement is appropriate. Alternatively, an automatic designation may be based upon an image-associated attribute. An image-associated attribute, as used herein, refers to any characteristic describing image-associated media. An image-associated attribute may comprise a primary or a secondary image-associated attribute. A primary image-associated attribute refers to attributes based on a dedicated image, including attributes based on the image content and image metadata. A secondary image-associated attribute refers to attributes based on other image-associated media not comprising the dedicated image, e.g., the text surrounding the image and associated metadata. Such image-associated attributes may include, without limitation, keywords, categories, classifiers, data, positions, sizes, values, colors, formats, titles, objects, scenes, and the like. For example, an image-based contextual advertisement may be appropriate for images having a particular characteristic, such as a specific image position e.g., the image positioned at the top-most portion of a webpage.

In an alternative embodiment, images for which image-based contextual advertisements are appropriate may be designated based on an indication by a user, media content publisher, advertisement service provider, search engine provider, program administrator or developer, and the like. An image for which an image-based contextual advertisement is appropriate may be designated, in one case, by selecting the image, hovering the image, specifying a webpage or website having the image, specifying image-associated attributes, specifying specific images, or specifying all images, and the like, for which an image-based contextual advertisement is appropriate. For example, assume a user or media content publisher specifies a webpage for which image-based contextual advertisements are appropriate. In such a case, each image presented within the webpage is deemed appropriate for presenting an image-based contextual advertisement and is designated as such.

Irrespective of whether an image for which an image-based contextual advertisement is deemed appropriate is automatically designated or designated based on an indication, one skilled in the art will recognize that such a designation may be indicated within code associated with the designated image, that is, code associated with, for example, the webpage, website, or image. Alternatively, the designation may be indicated within a storage device that stores data regarding images for which an image-based contextual advertisement is appropriate. In some embodiments, although an image may be designated as an image-based contextual advertisement may be associated, such a designation may not be predetermined. For example, in an embodiment where all images within a network may be deemed appropriate for presenting an image-based contextual advertisement, an explicit designation may not be provided for each image. Additionally, in an embodiment where a dynamic determination is made regarding images for which image-based contextual advertisements are appropriate, a predetermined designation may not be provided.

As previously mentioned, image-associated media refers to any electronic media associated with an image. Media may be associated with an image based on an indication, proximity, or any other relatedness. A user, media content publisher, advertisement service provider, search engine provider, program administrator or developer, or the like may provide an indication to associate particular media with an image. For example, when a media content publisher posts an image on the Internet, the media content publisher may also provide an indication of media to be associated therewith, e.g., a webpage, specific content within a webpage, other postings, or the like. Such an indication may comprise selecting associated media, identify associated media within code, or providing associated media, or an identification thereof, to a service provider or a storage device that stores such association information.

Proximity may also be utilized to associate media with an image. In embodiments, proximity may refer to, for example, position proximity, temporal proximity, or relation proximity. Proximity may be indicated utilizing values, directions, positions, locations, times, time durations, and the like. Position proximity may be used to associate an image with media positioned within a specific proximity to the image. By way of example only, in one embodiment, webpage position proximity may be used to associate media with an image. As such, any content within a webpage, and metadata associated therewith, may be associated with an image presented within the webpage. In another embodiment, character position proximity may be used to associate media with an image. In such a case, any text, values, symbols, and the like within a specific number of characters, e.g., 100 characters, from the image may be associated with the image. Temporal proximity may be used to associate an image with media that is published, created, uploaded, stored, or the like, at approximately the same time as the image. For example, assume a media content publisher posts additional content, e.g., blog postings, within a few days of posting the image for which a contextual advertisement is appropriate. In such a case, the content may be temporally proximate to the posting of the image and, thus, associated with the image. Relation proximity is used to associate an image with media based on related aspects of the image and media. Such related aspects may include related image-associated attributes, image-associated attributes occurrences, publishers, users, and the like.

One skilled in the art will appreciate that media associated with an image may be predetermined or dynamically determined. Media that is predetermined to be associated with an image may be indicated within code or indicated within a storage device that stores such associations. Such a predetermination may be made by users, media content publishers, advertisement service providers, program administrators or developers, and the like, or by an application or component, such as media referencing component 312. In an embodiment where media is dynamically associated with an image, the media referencing component 312 may be configured to determine the media related to the image.

Media referencing component 312 may reference image-associated media stored within a storage device, such as storage device 204. One skilled in the art will appreciate that such a storage device may reside within a server or end-user device hosting the image analyzing module 310 or within a server or end-user device remote from the image analyzing module 310. In embodiments where media referencing component 312 references image-associated media within a storage device, the storage device may obtain image-associated media by receiving or retrieving such media from a user, media content publisher, a webcrawler, program administrator or developer, and the like. Alternatively, the storage device may obtain image-associated media by receiving or retrieving such media from an application, module, or component, such as media referencing component 312, that determines or identifies such media associated with an image. Such a storage device may include an index that associates images with related media. By way of example only, assume an image-associated media comprises the web page containing a designated image. Further assume that a storage device obtains the image-associated media from a webcrawler that is utilized to create a copy of the webpage and index the webpage in a storage device. At a later time, media referencing component 312 may reference image-associated media within the storage device.

In another embodiment, media referencing component 312 may reference image-associated media via a network. For example, assume a user calls a webpage having code that indicates a contextual advertisement is appropriate for a designated image. In such a case, the media referencing component 312 may access and reference the image-associated media via the network. Referencing image-associated media via the network may include receiving or retrieving the image-associated media from the network or, alternatively, accessing and referencing the image-associated media over the network.

Media referencing component 312 may reference image-associated media automatically or based on an event. Image-associated media may be referenced automatically, for example, based on an algorithm or upon a webcrawler accessing an image, webpage, or website. In the alternative, image-associated media may be referenced based on an event, such as, for example, a user, media content publisher, or service provider indication, input, or selection to initiate a reference to an image-associated media; the introduction or modification of an image, website, or webpage to the network; the duration of a time; the occurrence of a time; or any other event that may initiate a reference to an image-associated media.

One skilled in the art will appreciate that, in some embodiments, media referencing component 312 may reference prospective image-associated media. For example, assume a published webpage does not include an image or, alternatively, includes an image that is not designated as appropriate for presenting an image-based contextual advertisement. In such cases, the webpage may be considered a prospective image-associated media. Accordingly, although the prospective image-associated media may not, at a specific instance, be associated with an image, media referencing component 312 may, nonetheless, reference the media as prospective image-associated media. In one embodiment, the prospective image-associated media may be analyzed and/or stored such that, at a later instance, an image may be associated with the prospective image-associated media.

The image attribute identifying component 314 is configured to identify one or more image-associated attributes (i.e., attributes based on image-associated media, such as image-associated media referenced by media referencing component 312). Image attribute identifying component 314 may identify relevant image attributes, all recognizable image attributes, or image attributes that exceed a particular threshold. In an embodiment where relevant image attributes are identified, image attribute identifying component 314 may utilize an algorithm or lookup system to determine the relevant image attributes. In an embodiment where image-associated attributes that exceed a particular threshold are identified, such a threshold may be based on input from a user, media content publisher, advertisement service provider, or program developer or administrator, or, alternatively, based on an algorithm or lookup table. By way of example, assume image-associated attributes, e.g., keywords, having a specific number of occurrences within the image-associated media may be identified, e.g., the term “zebra” appears five times within the webpage containing the designated image. As such, where the image-associated media, i.e., webpage, includes the term “zebra” six times, image attribute identifying component 314 may identify a keyword image attribute as “zebra.”

Image attribute identifying component 314 may identify image-associated attributes that comprise, for example, keywords, categories, classifiers, data, positions, values, sizes, colors, formats, titles, objects, scenes, and the like. Keyword attributes may include words that are presented within text. Classifiers may be utilized to classify an image-associated media, or portion thereof. An object classifier may classify an object presented within media. A scene classifier may classify a scene presented within media. A text classifier may classify text or values presented within media. An object classifier, a scene classifier, and a text classifier may utilize optical character recognition, or other recognition techniques, to detect objects, scenes, and/or text. Such classifiers may be trained against assembled training data and may improve as additional data is ascertained.

In one embodiment, image-associated attributes may comprise primary image-associated attributes. In such an embodiment, primary image-associated attributes may be based on textual aspects of the designated image and/or non-textual aspects of the designated image. Textual aspects of the designated image may include, for example, image metadata and user-generated data, e.g., tagging, and the like. Non-textual aspects of the designated image may include the image content, i.e., the content of the image displayed to a user, such as object image-associated attributes and scene image-associated attributes.

In addition to, or alternatively, image-associated attributes may comprise secondary image-associated attributes. In such an embodiment, image-associated attributes may also be based on textual aspects and/or non-textual aspects of the image-associated media. Textual aspects of the image-associated media may include, for example, text content of the image-associated media, metadata of the image-associated media, user-generated data for the image-associated media, and the like. Non-textual aspects of the image-associated media may include image content, video content, audio content, and the like.

Upon identifying image-associated attributes, in one embodiment, the image attribute identifying component 314 may extract the image-associated attributes. In such an embodiment, image attribute identifying component 314 may output the extracted image-associated attributes to the advertisement determining module 330 such that an advertisement may be associated with the image. In an alternative embodiment, the image attribute identifying component 314 may store the image-associated attributes, for example, in a storage device, such that the image-associated attributes may be communicated or retrieved at a later instance.

The advertisement analyzing module 320 is configured to analyze advertisements. In one embodiment, the advertisement analyzing module 320 may include an advertisement referencing component 322 and an advertisement attribute identifying component 324. The advertisement referencing component 322 is configured to reference an advertisement. In one embodiment, advertisement referencing component 322 may reference advertisements stored within a storage device, such as storage device 204. One skilled in the art will appreciate that such a storage device may reside within a server or end-user device hosting the advertisement analyzing module 320 or within a server or end-user device remote from the advertisement analyzing module 320. In an embodiment where advertisement referencing component 322 references advertisements within a storage device, the storage device may obtain advertisements by receiving or retrieving such advertisements from a user, media content publisher, webcrawler, advertisement service provider, program developer or administrator, or the like. Such a storage device may include an index utilized to organize the advertisements within the storage device.

Advertisement referencing component 322 may reference advertisements automatically or based on an event. Advertisements may be referenced automatically, for example, based on an algorithm or upon a webcrawler accessing an advertisement. In the alternative, advertisements may be referenced based on an event, such as, for example, the submission of an advertisement from an advertisement service provider; a user, media content publisher, advertisement service provider, or program administrator or developer providing an indication, input, or selection; the duration of a time; the occurrence of a time; or any other event that may initiate a reference to an advertisement.

An advertisement attribute identifying component 324 is configured to identify one or more advertisement attributes. As used herein, an advertisement attribute refers to any characteristic associated with the advertisement. Such an advertisement attribute may include, without limitation, a keyword, a category, a classifier, a datum, a position, a size, a color, a value, a format, a title, an object, a scene, and the like. Advertisement attributes may be based on textual aspects of the advertisement and/or non-textual aspects of the advertisement. Textual aspects of an advertisement may include, for example, text of a text advertisement, metadata and user-generated data, e.g., tagging, and the like. Non-textual aspects of the advertisement may include the image, audio, and/or video content of an advertisement.

Upon identifying advertisement attributes, in one embodiment, the advertisement attribute identifying component 324 may extract the advertisement attributes. In such an embodiment, advertisement attribute identifying component 324 may output the extracted advertisement attributes to the advertisement determining module 330 such that an advertisement may be associated with an image. In an alternative embodiment, the advertisement attribute identifying component 324 may store the attribute, for example, in a storage device such that the advertisement attribute may be communicated or retrieved at a later instance.

The advertisement determining module 330 is configured to determine one or more image-based contextual advertisements to apply to an image. In one embodiment, advertisement determining module 330 may include an attribute referencing component 332, a relevancy determining component 334, an advertisement ranking component 336, and an advertisement associating component 338.

The attribute referencing component 332 is configured to reference one or more image-associated attributes and/or one or more advertisement attributes. In one embodiment, attribute referencing component 332 may reference image-associated attributes and/or advertisement attributes by receiving or retrieving such attributes from image attribute identifying component 314 and/or advertisement attribute identifying component 324, respectively, or from any storage device utilized by image attribute identifying component 314 or advertisement attribute identifying component 324. Alternatively, attribute referencing component 332 may reference attributes by receiving or retrieving such attributes from another application or storage device or by identifying or determining such attributes.

The attribute referencing component 332 may reference image-associated attributes and/or advertisement attributes automatically or based on an event. Attribute referencing component 332 may reference such attributes automatically, for example, upon a webcrawler accessing an image, webpage, website, or advertisement. In the alternative, attribute referencing component 332 may reference such attributes based on an event, such as, for example, a user media content publisher, advertisement service provider, or program administrator or developer indication, input, or selection; the accessing of a website; the introduction or modification of an image, website, webpage, or advertisement; the duration of a time; the occurrence of a time; or any other event that may initiate a reference to attributes.

One skilled in the art will recognize that attribute referencing component 332 may reference any combination of image-associated attributes and advertisement attributes. For example, in one embodiment, attribute referencing component 332 may reference all image-associated attributes and advertisement attributes in a single instance. In another embodiment, attribute referencing component 332 may reference image-associated attributes pertaining to a single image and reference all advertisement attributes. In yet another embodiment, attribute referencing component 332 may reference image-associated attributes pertaining to a single image and reference advertisement attributes pertaining to a single advertisement in a single instance. Another embodiment may include referencing image-associated attributes pertaining to a single image in one instance and referencing advertisement attributes pertaining to a single advertisement image at a later instance. Any number of combinations may be employed to achieve the desired functionality within the scope of embodiments hereof.

The relevancy determining component 334 is configured to determine advertisements contextually relevant to an image. The relevancy determining component 334 may utilize an algorithm or lookup table, among other things, to make such a determination. Determining advertisements contextually relevant to an image may be based on, among other things, commonality and occurrences. For example, an advertisement may be determined relevant to an image where the image and the advertisement share at least one common keyword or object attribute. Such matching may apply with respect to any type or combinations of attributes. In one embodiment, relevancy determining component 334 may determine advertisements contextually relevant to an image based on a comparison of image-associated attributes and advertisement attributes. In such an embodiment, the image-associated attributes may include primary and secondary image-associated attributes.

By way of example only, assume an image displays coffee beans while the text surrounding the image discusses coffee sales. In such a case, a primary object image-associated attribute of “coffee” may be combined with a secondary keyword image-associated attribute of “sales” to determine the contextual relevance of one or more advertisements. As such, based on the combination of the primary attribute of the image and the secondary attribute of the image-associated media, an advertisement pertaining to coffee sales is deemed contextually relevant, rather than an advertisement pertaining to coffee machines. More contextually relevant advertisements may be identified where both primary and secondary image-based attributes are utilized.

One skilled in the art will appreciate that relevancy determining component 334 may perform a one-to-one comparison, a one-to-many comparison, or a many-to-many comparison. A one-to-one comparison may, for instance, be performed by comparing image-associated attributes pertaining to a single image with advertisement attributes pertaining to a single advertisement. Such one-to-one comparisons may be performed for a single image as compared to each of a plurality of advertisements, e.g., all advertisements, advertisements having a specific advertisement attribute, or the like, wherein each comparison is performed separately. A one-to-many comparison may, for instance, be performed by comparing image-associated attributes pertaining to a single image with advertisement attributes pertaining to multiple advertisements at approximately the same time. A many-to-many comparison may, for instance, be performed by comparing image-associated attributes pertaining to multiple images with advertisement attributes pertaining to multiple advertisements at approximately the same time.

Relevancy determining component 334 may determine the relevance of an advertisement to an image by performing a relevancy calculation, utilizing an algorithm or a lookup system, or employing any other mechanism to determine the relevance. Such a relevance may be indicated by a value, text, icon, symbol, or other identifier that indicates an advertisement's relevancy.

The advertisement ranking component 336 is configured to rank advertisements according to relevancy. In embodiments, advertisement ranking component 336 may rank all advertisements for which relevancy was determined by relevancy determining component 334. Alternatively, advertisement ranking component 336 may rank a portion of advertisements. In some embodiments, advertisement rankings may be determined while the advertisement relevancy is determined. The advertisement ranking component 336 may rank advertisements such that an advertisement with a highest relevancy to a given image is ranked the highest. In one embodiment, advertisement ranking component 336 may utilize image and/or advertisement preferences, as more fully discussed below, a clickthrough expectation, a user interest, a monetary value of the advertisement, and the like to rank advertisements.

The advertisement associating component 338 is configured to associate one or more image-based contextual advertisements with an image. One skilled in the art will appreciate that advertisement associating component 338 may associate any number of image-based contextual advertisements with an image. In one embodiment, the most relevant advertisement may be associated with the image. In an embodiment where multiple advertisements may be applied, in a simultaneous or cyclical manner, to an image, multiple advertisements may be associated with the image.

In one embodiment, advertisement associating component 338 may utilize advertisement relevance, as determined by relevancy determining component 334, and/or advertisement ranking, as ranked by advertisement ranking component 336, to determine one or more image-based contextual advertisements to associate with an image. In another embodiment, advertisement associating component 338 may additionally utilize image and/or advertisement preferences, as more fully discussed below, a clickthrough expectation, a user interest, a monetary value of the advertisement, and the like, to determine one or more image-based contextual advertisements to associate with an image.

In one embodiment, any of relevancy determinations, ranking results, and advertisement associations may be stored in a storage device for retrieval or communication at a later instance. In another embodiment, advertisement associating component 338 may communicate the results such that one or more image-based contextual advertisements may be applied to an image.

The contextual advertisement applying module 340 is configured to apply one or more image-based contextual advertisements to an image. In one embodiment, the contextual advertisement applying module 340 may include an advertisement integrating component 342, a presentation delivering component 344, and an advertisement presenting component 346.

The advertisement integrating component 342 is configured to determine the integration of one or more advertisements with an image. In one embodiment, advertisement integrating component 342 may integrate an advertisement with an image based on image preferences and/or advertisement preferences. Image preferences, as used herein, indicate a preference for an image and advertisement preferences indicate a preference for an advertisement. Such preferences may include, for example, color preferences, position preferences, formatting preferences, content preferences, and the like. One skilled in the art will appreciate that “preference” may comprise a desired integration or a required integration.

Color preference refers to the colors preferred for the image and/or the advertisement. In some embodiments, a color preference may be set forth by a user, media content provider, advertisement service provider, program developer or administrator, and the like. For example, metadata associated with an image may indicate a desire for an advertisement having a blue background so that, for example, the advertisement may blend in with the image or contrast with the image. In other embodiments, a color analysis, such as a dominant color analysis, may be performed to determine a color preference. Such a color analysis may performed via an algorithm based on a histogram of the image. As such, the analysis may determine a dominant color in a particular area, a dominant color for the entire image, the colors that are presented most frequently, a color for a particular object within the image, an average color for an area, and the like. The results of the color analysis may indicate a color preference.

Position preference refers to the position and/or size preferred for the image and/or advertisement. In some embodiments, a position preference may be set forth by a user, media content provider, advertisement service provider, program administrator or developer, or the like. For example, metadata associated with the image may indicate that advertisements of a certain size may be placed in the top right corner of the image. In other embodiments, a position analysis may be performed to determine a position preference. Such an analysis may include determining locations within the image that are bland and, if desired, corresponding location sizes. The results of the position analysis may indicate a position preference.

Format preference refers to the format preferred for an image and/or advertisement. An advertisement format preference may include, for example, a preference for a text advertisement, an image advertisement, a video advertisement, an animated advertisement, an audio advertisement, and the like, or even a preferred file format. One skilled in the art will recognize that format preferences may pertain to any formatting aspect or characteristic of an advertisement and/or image. Content preference refers to content preferred for an advertisement and/or an image. A format and/or content preference may be set forth or an analysis may be performed to determine a format or content preference. Such an analysis may determine specific formats, e.g., pixel size, desired to adequately display the advertisement or specific content desired to be displayed.

In one embodiment, image and/or advertisement preferences may be indicated within the metadata associated with the image or advertisement or stored within a storage device. In such a case, the image and/or advertisement preferences may be set forth by a user, media content provider, advertisement service provider, program developer or administrator, search engine provider, and the like. Alternatively, image and/or advertisement preferences may be dynamically determined or determined by advertisement integrating component 342.

In embodiments, advertisement integrating component 342 may determine the integration of one or more advertisements while, for example, image analyzing module 310 analyzes an image, advertisement analyzing module 320 analyzes an advertisement, or advertisement determining module 330 determines an advertisement to associate with an image. For example, as image analyzing module 310 analyzes an image, advertising integrating component may determine color preferences, position preferences, and the like.

Determining the integration of advertisements with an image may include verifying that a particular advertisement may be integrated with an image, determining how to integrate an advertisement with an image, and a combination thereof. The image preferences and advertisement preferences may be utilized to verify that a particular advertisement may be integrated with an image. For example, assume it is preferred that any advertisement applied to an image comprises a text advertisement. Further assume that a video advertisement is associated with the image. In such a case, advertisement integrating component 342 may verify that the associated advertisement comprises a text advertisement. As the associated advertisement does not comprise a text advertisement, advertisement integrating component 342 may disregard the selected advertisement and request or select another image-based contextual advertisement. One skilled in the art will recognize that advertisement associating component 338 may alternatively, or in addition to, verify that the particular advertisement is capable or desired to be integrated within an image.

In addition, image preferences and advertisement preferences may be utilized to determine how to integrate an advertisement with an image. In such a case, the image, the advertisement, or both, may be modified in one or more aspects. For example, assume it is preferred that any advertisement blends with respect to the image and comprises a large dimension. Further assume that advertisement integrating component 342 recognizes that the image background is blue while the advertisement background is red, and the advertisement background comprises a small dimension. In such a case, advertisement integrating component 342 may determine to edit the background color of the advertisement so that it blends with the image as well as to enlarge the advertisement to meet the requisite dimension or to request or select another image-based contextual advertisement.

The presentation delivering component 344 is configured to identify features to utilize to deliver an image-based contextual advertisement. The presentation delivering component 344 may, for example, identify whether to place the advertisement near the image, to overlay the advertisement on top of the image, or to stitch the advertisement into the image and, thereby, alter the image. Such an identification may, in one embodiment, be set forth in a storage device or metadata associated with the image or advertisement.

The presentation delivering component 344 may also identify the advertisement features utilized to deliver an image-based contextual advertisement. Features may include visual effects, e.g., blurring; image processing effects, e.g., transparency; scripting, e.g., zooming and alpha blending; resolution effect; and any other effect that may be applied to the image-based contextual advertisement. The blurring feature effect may be used to blur the image to make it less visible.

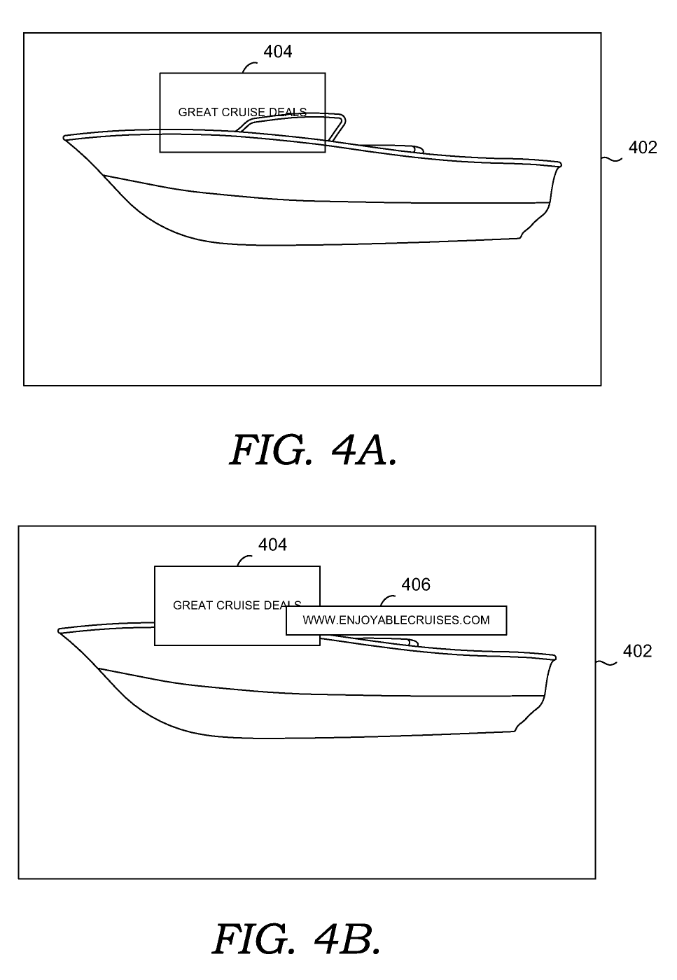

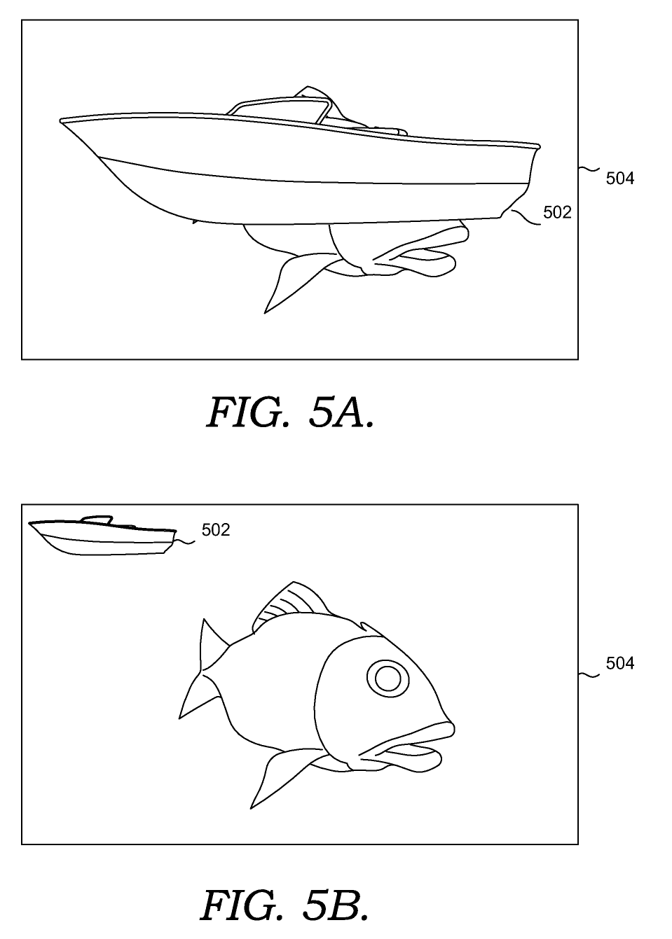

The transparency feature effect may be used to transparently alter advertisements, images, and the like. With reference to FIGS. 4A-4B, an exemplary display of a transparency feature effect is illustrated. An image 402 comprises a boat. In FIG. 4A, a contextual advertisement 404 is transparently presented. Assuming a user selects the advertisement or hovers over the advertisement 404, the advertisement 404 may increase intensity and may present an associated link 406, as shown in FIG. 4B. The zooming feature may be used to shrink and expand the advertisements, images, or a combination thereof. In one embodiment, an advertisement may slowly decrease in size and minimize to a corner. In such a case, if the advertisement is selected or a selector hovers over the attachment, the advertisement may increase in size. For example, with reference to FIGS. 5A-5C, an exemplary display of a zooming feature is illustrated. A contextual advertisement 502 comprising a boat is initially presented in an enlarged form within an image 504, as shown in FIG. 5A. The advertisement 502 may slowly be reduced in size and become positioned in a corner of the image 504 of FIG. 5B. Assuming a user selects the advertisement 502 or hovers over the advertisement 502, the advertisement 502 is increased in size such that it is displayed as it was originally displayed, as shown in FIG. 5C. The alpha blending feature effect may be used to fade one item into focus while fading another item out of focus.

The resolution feature effect may be used to present a low resolution image followed by a higher resolution image, e.g., a full-scale version of the image. In embodiments, the low resolution image, the higher resolution image, or a combination thereof may be integrated with an image-based contextual advertisement. For example, in one embodiment, a low resolution image may be initially presented. Such a low resolution image may include an image-based contextual advertisement. The image-based contextual advertisement may be presented with the initial low resolution image or upon the presentation of the initial low resolution image, e.g., the image-based contextual advertisement may be zoomed or blurred into the low resolution image. Upon presenting the low resolution image and image-based contextual advertisement, a higher resolution image may be presented in place of the low resolution image and image-based contextual advertisement.

Presentation delivering component 344 may identify features based on an indication from a user, media content publisher, advertisement service provider, program administrator, or the like. Such an indication may, for example, be provided within metadata or within a storage device. Alternatively, presentation delivering component 344 may dynamically identify features to use to deliver image-based contextual advertisements.

One skilled in the art will recognize that presentation delivering component 344 may reside on a server, end-user device, or a combination thereof. In some cases, feature effects may be hosted on the web-browser. In such a case, such a presentation delivering component 344, or portion thereof, may reside on the end-user device.

The advertisement presenting component 346 is configured to present the image-based contextual advertisement. In one embodiment, advertisement presenting component 346 may present the image-based contextual advertisement to an end-user device such that it may be displayed to the user. In another embodiment, advertisement presenting component 346 may present the image-based contextual advertisement to a user. The advertisement presenting component 346 may apply and present any features and any preference modifications to the image and/or advertisement.

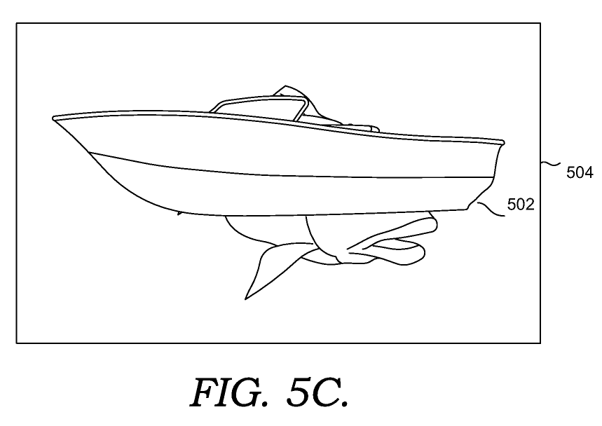

Referring now to FIG. 6, an exemplary method for analyzing an image in accordance with an embodiment of the present invention is presented. Initially, as indicated at block 610, image-associated media are referenced. Such image-associated media may include the image for which a contextual advertisement is appropriate as well as other media associated with the media, e.g. metadata and webpage. Thereafter, at block 620, one or more image-associated attributes are identified. In one embodiment, both primary and secondary image-associated attributes related to the image are identified along with image-associated attributes related to other image-associated media.

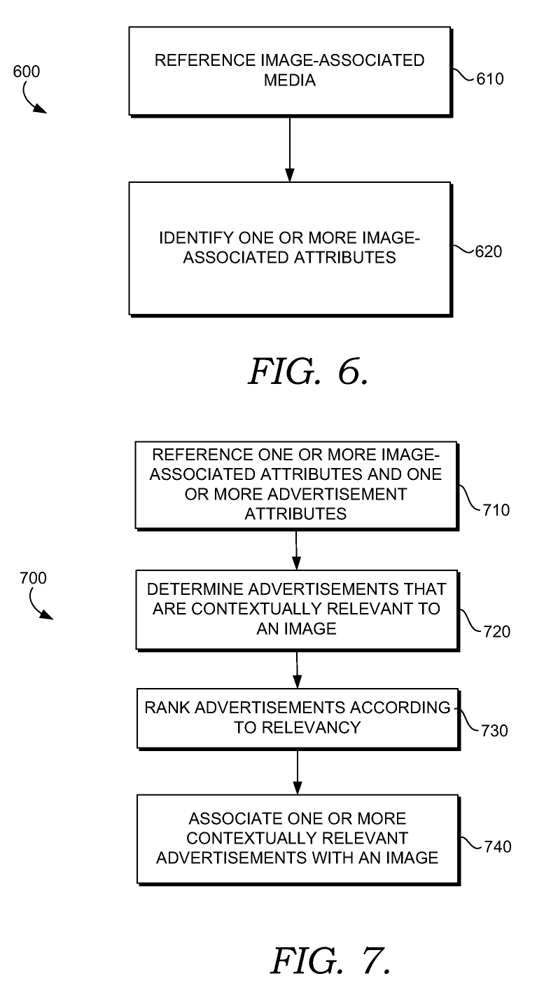

With reference to FIG. 7, in accordance with an embodiment of the present invention, an exemplary method for determining one or more image-based contextual advertisements to apply to an image is illustrated. Initially, as indicated at block 710, one or more image-associated attributes and/or one or more advertisement attributes are referenced. At block 720, advertisements that are contextually relevant to an image are determined. Such a determination may be made based on the image-associated attributes and advertisement attributes referenced. In embodiments, advertisements may be deemed contextually relevant where the advertisement and image include common attributes. Subsequently, at block 730, the advertisements are ranked according to relevancy. One or more contextually relevant advertisements are then associated with the image, as indicated at block 740.

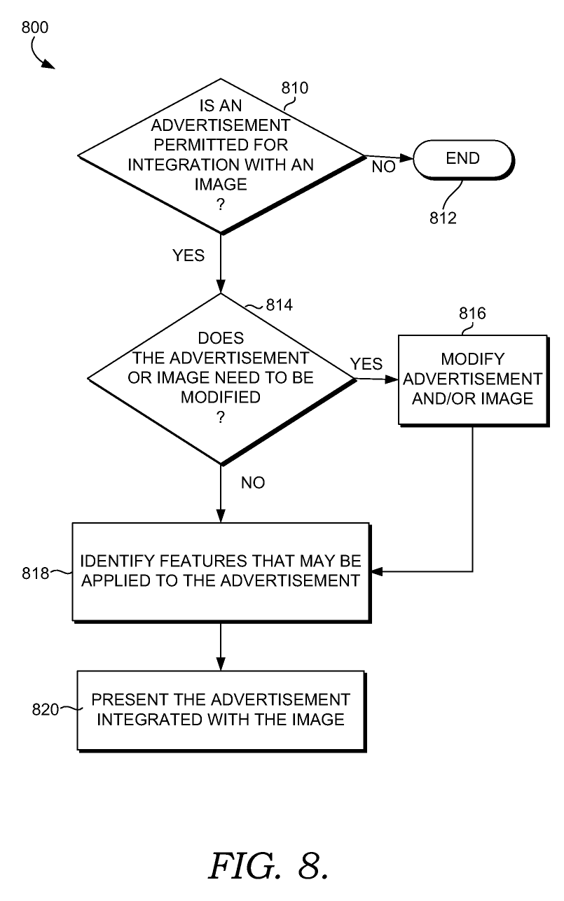

Referring now to FIG. 8, an exemplary method for applying an image-based contextual advertisement to an image, in accordance with an embodiment of the present invention, is illustrated. Initially, at block 810, it is determined whether an advertisement is permitted to be integrated with an image. If an advertisement is not permitted to be integrated with an image, the method ends at block 812. If, on the other hand, an advertisement is permitted to be integrated with an image, it is determined at block 814 whether the advertisement or image should be modified. If it is determined that the advertisement or image should be modified, the advertisement and/or image is modified at block 816. Thereafter, features that may apply to the advertisement are identified at block 818. If, however, it is determined at block 814 that the advertisement or image should not be modified, features that may apply to the advertisement are identified at block 818. At block 820, the advertisement is integrated with the image and presented.

Embodiments described herein are intended in all respects to be illustrative rather than restrictive. Alternative embodiments will become apparent to those of ordinary skill in the art without departing from the scope of embodiments described herein.

From the foregoing, it will be seen that embodiments of the present invention are well adapted to attain ends and objects set forth above, together with other advantages which are obvious and inherent to the systems and methods described. It will be understood that certain features and sub-combinations are of utility and may be employed without reference to other features and sub-combinations. This is contemplated by and is within the scope of the claims.

What is claimed is:

1. One or more computer-readable media having computer-executable instructions embodied thereon that, when executed, perform a method for determining image-based contextual advertisements to apply to an image, the method comprising:
referencing one or more image-associated attributes, wherein at least one of the one or more image-associated attributes comprises a primary image-associated attribute that relates to an first image-associated media comprising an image and at least one of the one or more image-associated attributes comprises a secondary image-associated attribute that relates to a second image-associated media; and
utilizing the one or more image-associated attributes to determine one or more advertisements contextually relevant to the image.

2. The computer-readable media of claim 1 further comprising referencing one or more advertisement attributes.

3. The computer-readable media of claim 2 further comprising utilizing the one or more advertisement attributes to determine one or more advertisements contextually relevant to the image.

4. The computer-readable media of claim 1, wherein each of the one or more image-associated attributes comprise a keyword, a category, a classifier, a datum, a position, a size, a value, a color, a format, a title, an object, a scene, and a combination thereof.

5. The computer-readable media of claim 3, wherein the one or more advertisement attributes comprise a keyword, a category, a classifier, a datum, a position, a size, a value, a color, a format, a title, an object, a scene, and a combination thereof.

6. The computer-readable media of claim 3, wherein determining one or more advertisements contextually relevant to the image comprises comparing the one or more image-associated attributes with the one or more advertisement attributes.

7. The computer-readable media of claim 1, wherein the one or more image-associated attributes comprise a characteristic describing at least one an image-associated media.

8. The computer-readable media of claim 7, wherein the at least one image-associated media comprises electronic media information associated with an image or prospectively associated with an image.

9. The computer-readable media of claim 8, wherein the electronic media information comprises a video, an audio, a song, a movie, a multimedia presentation, a slide presentation, a document, an image, a game, a website, a webpage, a blog entry, or a portion thereof.

10. A method for applying image-based contextual advertisements to images, the method comprising:
identifying one or more preferences for one of a contextually relevant advertisement or an image, wherein the one or more preferences comprise a color preference, a position preference, a format preference, a content preference, or a combination thereof;
determining the integration of the advertisement contextually relevant with the image based on the one or more identified preferences; and
applying the contextually relevant advertisement to the image.

11. The method of claim 10 further comprising referencing the advertisement contextually relevant to the image.

12. The method of claim 10, wherein determining the integration of the advertisement with the image comprises determining modifications to apply to one of the advertisement or the image.

13. The method of claim 12, further comprising applying one or more modifications to the one of the advertisement or the image.

14. The method of claim 13, wherein the one or more modifications comprise a color modification, a size modification, a format modification, and the like.

15. The method of claim 10 further comprising verifying that the contextually relevant advertisement may be applied to the image, wherein the verification comprises utilizing the one or more preferences.

16. The method of claim 10 further comprising presenting the contextually relevant advertisement.

17. The method of claim 16 further comprising identifying one or more features to utilize in presenting the contextually relevant advertisement.

18. The method of claim 17, wherein the one or more features comprise a visual effect, an image processing effect, a script effect, or a combination thereof.

19. A computerized system for applying image-based contextual advertisements to images, the system comprising:
an image analyzing module configured to analyze one or more image-associated media and identify one or more image-associated attributes, wherein at least one of the one or more image-associated attributes comprise a primary image-associated attribute and at least one of the one or more image-associated attributes comprise a secondary image-associated attribute;
an advertisement analyzing module configured to analyze one or more advertisements and identify one or more advertisement attributes;
an advertisement determining module configured to determine one or more contextually relevant advertisements, wherein one or more contextually relevant advertisements are determined based on the at least one primary image-associated attribute, the at least one secondary image-associated attribute, and the one or more advertisement attributes; and
a contextual advertisement applying module configured to apply the one or more contextually relevant advertisements to the image based on one or more preferences, one or more features, or a combination thereof.

20. The system of claim 19, wherein the contextual advertisement applying module verifies that the contextually relevant advertisement may be applied to the image, wherein the verification comprises utilizing the one or more preferences.
